(19) United States
(12) Patent Application Publication
(10) Pub. No.: US 2020/0263793 A1
(43) Pub. Date: Aug. 20, 2020

(54) PORT PLATE WITH INCREASED RIGIDNESS AND METHOD FOR PRODUCING SUCH PORT PLATE

(71) Applicant: Danfoss Power Solutions GmbH & Co. OHG, Neumünster (DE)

(72) Inventor: Eckhard SKIRDE, Nordborg (DK)

(21) Appl. No.: 16/647,057

(22) PCT Filed: Sep. 7, 2018
(86) PCT No.: PCT/EP2018/074224

§ 371 Date: Mar. 13, 2020

(30) Foreign Application Priority Data
Sep. 14, 2017 (DE) 10 2017 121 334.1

(51) Int. Cl. F16K 3/02

(52) U.S. Cl. CPC F16K 3/029; F16K 3/0218

(57) ABSTRACT

The invention relates to a port plate 10, 11 that is used as a valve plate or a bearing plate. The port plate 10, 11 comprises a fluid blocking surface section 15 and a fluid passage surface section 13, 14 that is arranged within said at least one fluid blocking surface section 15. Structural reinforcement elements 12, 19 are arranged within the fluid passage orifice of the fluid passage surface section 13, 14.

### CROSS-REFERENCE TO RELATED APPLICATIONS

This application is a National Stage application of International Patent Application No. PCT/EP2018/074224, filed on Sep. 7, 2018, which claims priority to German Patent Application No. 10 2017 121 334.1, filed on Sep. 14, 2017, each of which is hereby incorporated by reference in its entirety.

### TECHNICAL FIELD

The invention relates to a port plate for a fluid throughput regulating device that comprises at least one fluid blocking surface section and at least one fluid passage surface section that is arranged within said at least one fluid blocking surface section. Furthermore, the invention relates to a fluid valve unit comprising a port plate, a fluid working device comprising a port plate and a method for producing a port plate.

### BACKGROUND

When it comes to hydraulic circuits, high pressures have to be handled by the devices involved. This not only relates to hydraulic storage tanks, hydraulic valves, hydraulic conduits and the like but also particularly to hydraulic consumers and hydraulic pumps. With nowadays hydraulics, usually pressures in the order of 200 bar to 500 bar are used. To increase the performance of the hydraulics, even higher pressures are envisaged and are sometimes already used. Pressures in the order of 500 bar and above are realistic.

Irrespective of the pressure limit that is chosen, huge mechanical strains act on the devices involved due to the hydraulic pressure acting on the surfaces they come into contact with. This inevitably leads to a certain amount of elongation and/or deformation of the respective parts. While these effects are sometimes not problematic, they can pose significant problems in certain applications and/or for some parts.

As an example, if a fluid conduit (a tube or a hose) increases in diameter due to the pressure load, this can be easily handled with by providing a sufficient play to neighbouring parts. This play can be provided by a sufficient spacing between the respective part and its neighbouring part. Furthermore, the thus provided spacing can be filled (in part) with a resilient material. An example are holding clamps (made of a plastic material for example) that hold a tube. Possibly, a resilient material (rubber or the like) is placed between the holding clamp and the tube. Even in case different devices come into contact with each other, this is sometimes unproblematic, in particular when the elongation/deformation of the contacting parts takes place in a corresponding way. Then, despite of the deformation and/or elongation of said parts, there is no (or at least hardly any) relative deformation/elongation with respect to the neighbouring parts.

Sometimes, it is also possible to anticipate the elongation/deformation when designing the respective part. However, this is usually only a feasible option if the respective part is subject to a more or less constant pressure during operation.

A particular problem occurs therefore, if a certain part is exposed to strongly varying pressure, whilst it has to contact a different part that is exposed to high pressure in a non-corresponding way. The problem becomes even more predominant if the respective parts have to move with respect to each other, in particular in an essentially fluid-tight way.

Such very adverse conditions are the usual working environment for hydraulic pumps, hydraulic motors and hydraulic working machines (devices that can be operated both as a hydraulic motor and as a hydraulic pump).

Perhaps one of the most critical part that is used in such devices are port plates, like bearing plates and valve plates. These devices are used as fluid inlet and/or fluid outlet valves. They are plates that show some fluid orifices and that are moved relative to each other (normally rotated with respect to each other). Since they at least partly connect to a pumping chamber, at least their exposed parts are repetitively exposed to strongly varying pressures (usually between ambient pressure and maximum system pressure). Nevertheless, they have to be moved with respect to each other without too much mechanical friction, maintaining at the same time a good seal for the hydraulic fluid to avoid any excessive loss of efficiency.

The standard approach in the state-of-the-art is to make the respective plates as rigid as possible. This goal can be achieved by using harder materials (for example using hard steel alloys instead of standard steel), by designing the respective devices thicker, or by using supporting ribs or other stiffening structures on the surface of the plates (where those structures can usually be used on the non-contacting surface of the valve disc and the plate disc, only, if at all).

While these approaches work in practice feasibly good, they nevertheless show certain disadvantages. Disadvantages are, for example, increased cost (for providing hard alloys), increased weight (by using reinforcing structures or increasing the thickness of the respective parts) or increase in mounting space (increasing thickness of the respective parts and/or providing reinforcing ribs).

It is therefore obvious that there is still room for improvements.

### SUMMARY

It is therefore an object of the present invention to provide a port plate for a fluid throughput regulating device, comprising at least one fluid blocking surface section and at least one fluid passage surface section that is arranged within said at least one fluid blocking surface section in a way that it is improved over port plates that are known in the state-of-the-art. Another object of the invention is to suggest a fluid valve unit that is improved over fluid valve units that are known in the state-of-the-art, to suggest a fluid working device that is improved over fluid working devices that are known in the state of the art; and to suggest a method for producing a port plate that is improved over methods for producing port plates that are known in the state of the art.

It is therefore suggested to design a port plate for a fluid throughput regulating device, comprising at least one fluid blocking surface section and at least one fluid passage surface section that is arranged within said at least one fluid blocking surface section in a way that at least one structural reinforcement element is arranged within the fluid passage orifice of said at least one fluid passage surface section. Using this design, it is surprisingly possible to realise significant advantages by accepting—as it turns out—comparatively small disadvantages. Therefore, when considering the complete device, a possibly even significantly enhanced overall design can be realized. So far, it was firmly believed that the fluid orifice that is provided for the fluid flux (at least under certain positions of the device) has to be kept clear of all obstacles because otherwise the inevitably resulting increased fluid flow resistance would negatively influence the effectivity of the device to an unacceptable extent. As it turns out, however, the increase of fluid flow resistance is surprisingly low, in particular if the at least one structural reinforcement element is designed in an appropriate way. It has to be also kept in mind that a possibly occurring increased fluid flow resistance due to the at least one structural reinforcement element can be compensated by increasing the area of the respective fluid passage surface section (in particular with respect to the reference size without a reinforcement element, i.e. with reference to the size of the basic shape). If the area(s) of the at least one reinforcement element that faces the fluid flux is relatively small, a corresponding increase in area of the fluid passage surface section is comparatively small (if necessary at all). Surprisingly, the inventors figured out that the at least one structural reinforcement element can even enhance the fluid flow throughput (or keep it at an essentially identical level), at least under certain operating conditions and/or using certain designs. This seems to be due to the fact that by providing a plurality of individual sub-orifices (due to the separating effect of the at least one structural reinforcement element) the fluid flow through the respective sub-orifices becomes more laminar/shows less turbulent fluid flow. Since less vortices occur in the flowing fluid, the fluid flow throughput can then possibly be increased to an extent that it is higher than expected. A “port plate” in the context of this application might be considered to be a device whose lateral dimensions, as seen along its large-dimensioned surface, are significantly larger as compared to its thickness (a limiting factor/fraction of at least 5, 10, 25, 50, 75 or 100 might be used; so this constitutes some kind of a “flat element”). The large-dimensioned surface also bears at least one orifice for fluid flow throughput. Although it is preferred that the large-dimensioned surface follows essentially a flat plane, this is not necessarily required. In particular, at least parts of the large-dimensioned surface might be bent, provided with a certain shape, show protrusions or the like. In particular, recesses or cut-outs that reduce the thickness of the port plate (possibly including a thickness of zero, so that no material is remaining anymore) are usually not to be considered for the definition of the contour of the port plate. Considering these definitions, in particular plates or plate-like devices, discs or disc-like devices or the like are to be considered as a port plate. The surface section of the at least one fluid blocking surface section and the surface section of the at least one fluid passage surface section are likewise to be considered to be usually aligned more or less parallel to the large-dimensioned surface of the port plate. Of course, the port plate will usually show some surfaces which are more or less parallel to the surface normal of the port plate/that are more or less parallel to a surface normal of the large-dimensioned surface of the port plate and/or that are that are more or less parallel to a height axis of the port plate. However, surface areas with such an alignment are normally comparatively small, in particular when compared to the large-dimensioned surfaces of the port plate. Usually, the at least one fluid passage surface section is designed as a hole, whose shape can be essentially arbitrary. In particular, circular holes, rectangular holes, kidney shaped holes or slits, elongated holes or the like can be envisaged. According to the present document the shape is normally to be considered with respect to the “basic shape”, i.e. with respect to its shape when considered without its respective at least one structural reinforcement element. Since the at least one structural reinforcement element usually divides the respective fluid passage surface section into two or more separated sections (although this is not necessarily required), this can be considered in a way that the fluid passage surface section is now subdivided into a plurality of smaller sized fluid passage surface sections that may be addressed as fluid passage surface sub-sections, fluid passage sub-orifices, sub-orifices, fluid passage sub-sections, sub-passages, fluid sub-passages, sub-sized passages, or the like. Furthermore, normally at least one, several, a plurality, the majority or (essentially) all of the at least one fluid passage surface section will be completely surrounded by at least one of the at least one fluid blocking surface sections. However, this is not mandatory. Instead, it may be possible that at least one, several, a plurality, the majority or (essentially) all of the fluid passage surface section(s) is/are arranged at the side of the respective fluid blockage surface section of the port plate, so that it is sort of open to the outside and/or so that the fluid passage surface section can be considered to be a usually comparatively large sized recess that protrudes into the fluid blocking surface section of the port plate/into the port plate. Since the at least one structural reinforcement element is provided, designed and/or arranged in a way that the port plate will become more resistant to elongations/deformations with respect to a mechanical load onto the port plate, in particular with respect to a mechanical load like an applied fluid pressure load that occurs during standard operating conditions of the device the port plate is used for, in the device in which the port plate is used in will typically show an improved behaviour over similar port plates/devices that are known in the state of the art. In particular, the port plate/the resulting device may show less mechanical wear, less mechanical friction when driven, less hydraulic fluid losses, less formation of micro-cracks due to the repetitive application of a load and the like. Of course, it is possible that the at least one structural reinforcement element is used in addition to already foreseen measures (like structural reinforcement ribs, stronger materials and/or a thicker port plate, i.e. a port plate with an increased height). However, it is likewise possible that the at least one structural reinforcement element is used for at least partially replacing at least one, several, a plurality, the majority or (essentially) all of the previously used measures for making the port plate more rigid. Therefore, it is possible that the thickness remains the same, as compared to a previous design, while any structural reinforcement ribs that were arranged on one large-dimensioned surface of the port plate might be discontinued. Also, it is possible that both the ribs are discontinued and the height is reduced. Other combinations can of course be employed as well. With respect to the use of at least one structural reinforcement element in addition to already present measurements for making the port plate more rigid, it should be noted that such a design might be advantageous as well, since any deformation/elongation under a mechanical load can be further reduced, which, of course, can prove to be advantageous. Likewise, the extent of at least one of the previously used measures (or more) can be reduced (for example a slightly smaller thickness of the plate can be used; fewer ribs can be used on the rear side of the plate; and the like).

Although the port plate can be used for a variety of purposes and can be designed as a variety of devices, it is particularly suggested that the port plate is designed and arranged as a valve plate and/or as a bearing plate for a fluid working machine. Preferably, the port plate can be designed and arranged as a device for a high-pressure fluid working machine, more preferred for a hydraulic fluid working machine, even more preferred for a high-pressure hydraulic fluid working machine. Then, the port plate can show its intrinsic features and advantages to a particularly large extent. This is of course particularly advantageous. Consequently, the resulting device, the port plate according to the present suggestion is used for, can be correspondingly improved as well. A fluid working machine can be in particular of fluid pump or a fluid motor. Furthermore, it can be a device that can be operated both as a fluid motor and as a fluid pump. High-pressure is normally considered to be in the 200 bar, 300 bar, 400 bar or 500 bar and up-region (meaning 200 bar and more, 300 bar and more and so on). Fluid can be any type of liquid or gas, including a mixture of both. Furthermore, it can be (partially) a hypercritical fluid, where no distinction between fluid and gas can be made any more. It is not problematic, if a certain amount of solid particles is contained in the respective fluid (i.e. some kind of a suspension or smoke). A valve plate and a bearing plate are typically employed in combination to be used as some kind of an actuated valve, where their state is dependent on the position of the valve plate and the bearing plate relative to each other. Using such a valve plate/bearing plate combination, the behaviour of an actuated valve with a different design can be “mimicked” in an easy and reliable way. Typically, such valve plate/bearing plate combinations are used for swash plate fluid machines, wobble plate fluid machines, bent axis fluid machines and/or the like.

It is further suggested to design the port plate in a way that a plurality of structural reinforcing elements is provided in the fluid passage orifice of said at least one fluid passage surface section, where said plurality of structural reinforcing elements is preferably at least in part interconnected with each other, more preferably at least partially forming a truss-like design and/or a honeycomb-like design. Using a plurality of such structural reinforcing elements, the rigidity of the respective port plate can usually be further enhanced. This is particularly true if the plurality of reinforcing elements is sort of interconnected with each other, forming some kind of a mesh, interconnected structure or the like, so that the respective reinforcing elements reinforce each other. Nevertheless, at least in certain operating environments, even a single structural reinforcing element can prove to be sufficient, in particular if the respective structural reinforcing element shows a certain design, shape or the like. The previously suggested truss-like designs and/or honeycomb-like designs of the structural reinforcing elements typically show a particularly high structural integrity (meaning resulting in a particularly rigid port plate), while comparatively little material is needed for the structural reinforcing elements, which means in turn that only a comparatively small amount of the fluid passage orifice will be “blocked” by the structural reinforcing elements, meaning that only comparatively little fluid flow area is blocked. This way, the fluid flow properties are only lowered (if at all) to a relatively small extent. This, of course, can be compensated by providing a larger area for the respective fluid passage surface section, as previously mentioned (if necessary at all). Of course, an even more rigid port plate can be realized if not only a single fluid passage surface section is provided with at least one structural reinforcement element, but instead if several, a plurality, the majority or even (essentially) all of the fluid passage surface sections are provided with at least one structural reinforcement element. It should be noted that it is possible that at least two, some, a plurality of, the majority of or even (essentially) all of the fluid passage surface sections show a similar design with respect to the at least one structural reinforcement element (if they show at least one reinforcement element at all), in particular with respect to the number, the shape, the design, the size, the interconnectedness and the like of said at least one structural reinforcement element. However, it is also possible that (at least some of) these features differ at least in part for at least some of the fluid passage surface sections that do show at least one structural reinforcement element.

Although essentially every shape may be used, it is preferred if the port plate is designed in a way that at least one structural reinforcement element is designed in a way that it shows fluid flow enhancing properties. This has to be particularly understood with respect to the standard direction (or possibly standards directions) of the fluid flowing through the respective at least one fluid passage surface section. Such a fluid flow enhancement can be realized by employing a cross sectional shape of the respective structural reinforcement elements that shows a comparatively low fluid flow resistance for the passing fluid in question (typically a low cw-number), by possibly using a certain surface structure of the structural reinforcement element (so that the boundary layer along the surface of the structural reinforcement element/fluid passage orifice stays laminar as much as possible), by providing a certain size of the sub-orifices (so to increase the quota of laminar flow) and similar properties. As such, these measures are known in the state of the art and are as such usually known to a person skilled in the art. This way, any adverse effects (if present at all) of the at least one structural reinforcement element can be minimised. However, sometimes even an enhancement of fluid flow throughput can be realised, as already mentioned.

Furthermore, it is suggested to design the port plate in a way that at least one structural reinforcement element is connected to said at least one fluid blocking surface section along a circumferential part of the respective fluid passage surface section. This way, a particularly simple and yet mechanical stable fixation of the at least one structural reinforcement element can be realized. In particular, it is not necessary that parts do necessarily protrude from the large-dimensioned surface of the respective port plate, so that the respective port plate can have a preferred shape and/or can be more universally applied.

Further, it is possible that the port plate is designed in a way that said at least one structural reinforcement element and/or said at least one fluid blocking surface section is/are designed at least in part as a single piece. It is possible that two or more structural reinforcement elements are designed as a single piece. Likewise, it is possible that two or more fluid blocking surface sections are designed at least in part as a single piece. Furthermore, it is possible that one structural reinforcement element (or a plurality of structural reinforcement elements and one fluid blocking surface section are designed at least in part as a single piece. Furthermore, it is possible that a structural reinforcement element and a fluid blocking surface, or a plurality of surface blocking surface sections are designed at least in part as a single piece. Therefore, all possible combinations are meant to be envisaged by the initial statement. By using such a design, the mechanical stability and the lifetime of the respective element can be enhanced. Furthermore, it is even possible that the machining of the respective port plate can be simplified as well.

Further, it is suggested to design the port plate in a way that essentially no structural reinforcement element protrudes above at least one surface side that is formed by at least one fluid blockage surface section and/or in that said port plate forms essentially a planar contour on at least one surface side. This way, the port plate can be applied more universally. When saying that the port plate forms essentially a planar contour on at least one surface side, this usually includes the feature that the respective end(s) of the structural reinforcing element(s) do not protrude and/or do not form a recess/backstep with respect to the “normal” surface area (large surface area) of the port plate. Preferably, this feature is present on the surface side, where the port plate comes into contact with a second port plate (when employed in such an arrangement, in particular in a valve unit arrangement, comprising two port plates). The planar contour feature may be present for one or both (possibly even more) of the port plates in such an arrangement. More preferably, the planar contour feature is present on both surface sides of the port plate(s). Expressed in different words, this can be described in a way that the structural reinforcing element shows at least partially an essentially “full height”, i.e. that the height of the respective structural reinforcement element (section) is essentially equivalent to the thickness of the respective port plate (at least) in the vicinity of the structural reinforcing element. It is even possible that a rotation of a plate-like contour shows less fluid friction with respect to the rotary movement of a standard port plate, when used in a “final” device (usually a rotational movement is performed). Furthermore, mounting space can be saved by such a design. An essentially planar contour on at least one surface side of the port plate is to be understood in a way that recesses or holes are not to be considered to be a variation from the planar contour, in particular when it comes to fluid passage surface sections and/or fluid passage orifices. So, the planar contour might be replaced by a terminology like “structural clearance” or something similar. Only for completeness: when talking about a “planar contour” this can relate both to a scale that relates to essentially the complete port plate (i.e. the complete contour of the whole plate is planar), but can also relate to a local understanding of the respective plate's surface (so that a curved port plate, for example a bowl-like shaped port plate, can still show the feature of a planar contour in a local sense).

Even further, it is suggested to design the port plate in a way that at least one of said at least one fluid passage surface sections has a kidney like shape and/or that the port plate is designed in a way that said at least one of said at least one fluid passage surface sections is used for alternately enabling and blocking/hindering a fluid flow through said fluid passage surface section in combination with an additional device. “Hindering” is usually to be considered to be “severely hindering” the respective fluid flow i.e. the fluid flow throughput should be less than 1/10, 1/25, 1/50, 1/75 or 1/100 of the maximum possible fluid flow throughput. In particular, a “blocking apart from (intended and/or unintended) leakage flows/residual flows” is meant to be possibly envisaged by the terms “blocking” and “hindering”. It is to be noted that the suggested port plate is particularly well suited for such a use due to its intrinsic properties and advantages. In particular, in light of the repetitive mechanical loading and unloading (usually by way of applied fluid pressure) the increased stiffness of the respective port plate, in particular with respect to elongation and/or deformation due to mechanical loads, can prove to be particularly advantageous.

Even more, it is suggested that the port plate is at least partially manufactured using at least one manufacturing technique, taken from the group comprising material removal techniques, additive manufacturing techniques, 3-D printing techniques, moulding techniques, sintering techniques, material connection techniques, soldering techniques, welding techniques and pressure welding techniques. Such manufacturing methods are as such known in the state of the art. Depending on the exact design, one or a combination of the mentioned manufacturing techniques (and possibly even more) can be used. In particular when it comes to additive manufacturing techniques and/or 3-D printing techniques, it is possible to design the port plate with structures showing an extremely high degree of freedom and/or that are hard to achieve (if possible at all) using “standard manufacturing techniques” (i.e. in particular manufacturing techniques deviating from additive manufacturing techniques/3-D printing techniques). Only as an example, using additive manufacturing techniques/3-D printing techniques, particularly effective cross-sectional shapes of the structural reinforcing elements can be achieved that do show an only limited fluid flow resistance (like ellipsoidal crosssectional shapes, drop-like cross-sectional shapes or the like).

Furthermore, it is suggested that a valve unit comprises at least two elements that can be moved respective to each other, in particular that can be rotated relative to each other, wherein at least one of said at least two elements is designed at least in part as a port plate according to the previous suggestion. Typically, it is preferred if both (or more) of said at least two elements are designed as a port plate according to the previous suggestion. When using such a port plate/such port plates, the respective fluid valve unit can show a particularly advantageous behaviour, in particular when it comes to low mechanical friction, low hydraulic fluid losses, low mechanical wear, little generation of micro cracks due to the repetitive loading and unloading, and the like. In addition, the fluid valve unit will show the already mentioned features and advantages as previously described, at least in analogy. Additionally, the fluid valve unit can be modified in the previously described sense, at least in analogy.

Preferably, in the valve unit at least a first one of said at least two elements that can be moved relative to each other shows at least a structural reinforcement element that forms at least partly an essentially planar contour on at least the surface side that is neighbouring at least a second one of said at least two elements. Preferably, both (all) neighbouring surface sides of the at least two elements do show this feature. Even more preferred, this feature of an at least essentially planar contour is present on both surface sides of at least one, preferably a plurality, or all of the elements of said valve unit.

Furthermore, a fluid working device is suggested that comprises at least one fluid valve unit according to the previous suggestion and/or at least one port plate according to the previous suggestion. Such a fluid working device will be particularly advantageous and will show the already described features and advantages, at least an analogy. Additionally, the respective fluid working device can be modified in the previously described sense as well, albeit in analogy.

Even further, a method for producing a port plate according to the previous suggestion, a method for producing a fluid valve unit according to the previous suggestion and/or a method for producing a fluid working device according to the previous suggestion is suggested, wherein at least in part at least a manufacturing technique is used that is taken from the group comprising material removal techniques, additive manufacturing techniques, 3-D printing techniques, moulding techniques, sintering techniques, material connection techniques, soldering techniques, welding techniques, and pressure welding techniques. Using this method, the respective port plate, fluid valve unit and/or fluid working device can be manufactured very efficiently. This is particularly true for certain designs of the fluid valve unit, the fluid working device and/or the port plate with respect to additive manufacturing techniques and/or 3-D printing techniques. Using such techniques, it might be realistically possible for the first time to achieve a certain design, in particular with respect to certain structural reinforcement elements and their respective cross-sections. Of course, the method can show the indicated features and advantages in analogy as well. Even further, the method may be modified in the previously indicated sense as well, at least in analogy.

### BRIEF DESCRIPTION OF THE DRAWINGS

Further advantages, features, and objects of the invention will be apparent from the following detailed description of the invention in conjunction with the associated drawings, wherein the drawings show:

FIG. 1: a possible design of a bent axis hydraulic pump, comprising a valve plate and a bearing plate as a valve device for the pumping chambers in a schematic cross section;

FIG. 2: a possible embodiment of a valve plate and of a bearing plate in a schematic top view;

FIG. 3: two possible embodiments for reinforcing structures in a schematic top view;

FIG. 4: a schematic cross section through the walls of the reinforcing structure according to different embodiments.

### DETAILED DESCRIPTION

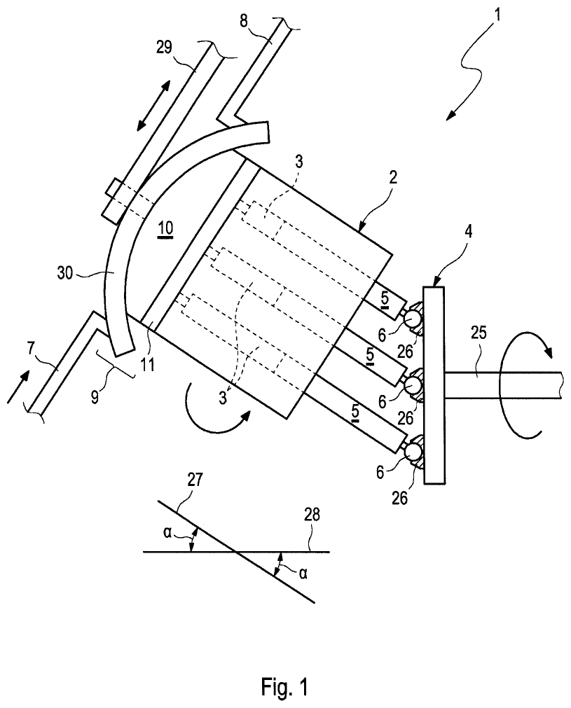

In FIG. 1 a possible embodiment for a so-called bent axis hydraulic pump 1 is shown in a schematic cross section. The basic design of a bent axis hydraulic pump 1 as shown in FIG. 1 is known in the state of the art. The presently shown embodiment is a variant of a pumping device. Other exemplary embodiments are a variable swash plate displacement type, a variable wobble plate displacement type and/or a fixed displacement type.

In the presently shown embodiment, a drum 2 with a plurality of cylindrical cavities 3 is rotated (indicated by an arrow near the lower-left side of drum 2 in FIG. 1). The rotation of drum 2 is introduced by a rotating shaft 25 (indicated by a rotating arrow around rotating shaft 25 in FIG. 1) via swash plate 4. The rotational movement can be introduced by any kind of device, like a combustion engine, an electric motor and so on (not shown). For transferring the rotational movement from the rotating shaft 25 to the drum 2, the swash plate 4 and the rotating drum 2 are connected to each other in a torque-proof manner. For this, the pistons 5 that are slidably contained in the cylindrical cavities' 3 of the drum 2 (in which they move back-and-forth under the rotating movement of drum 2 and swash plate 4) are placed with their piston feet 6 in retaining supports 26 that are arranged on the surface side of swash plate 4 that faces the drum 2. The connection between the piston feet 6 and the respective retaining supports 26 is established using a positive form-fitting interconnection, so that the two parts (pistons 5 and swash plate 4) can be rotated with respect to each other, but no translational movement can occur. Therefore, the piston feet 6 cannot lift off the surface of the swash plate 4. Therefore, a back-and-forth movement of the pistons 5 in their respective cylindrical cavities 3 can be ensured. The back-and-forth movement of the pistons 5 in their respective cylindrical cavities 3 results in a cyclically varying volume of the cylindrical cavities 3, so that a pumping action for fluid can be performed.

As indicated in FIG. 1, the longitudinal axis 27 of drum 2 (and therefore the longitudinal axis of the pistons 5/the cylindrical cavities 3 for retaining the pistons 5) are arranged at an angle α to the surface normal 28 of the swash plate's 4 surface. This angle α is not necessarily fixed (depending on the design of the bent axis hydraulic pump 1). In the presently shown embodiment, a moving rod 29 that can be moved back-and-forth (as indicated by a double arrow in FIG. 1) can be set to an appropriate position by a suitable actuator (not shown). The different positions translate into different angles α between the longitudinal axis 27 of drum 2 and the surface normal 28 of swash plate 4. Depending on the angle α, the overall length of the back-and-forth movement of the pistons 5 in their respective cylindrical cavities 3 can be varied.

In the presently shown embodiment, the valve plate 10 is attached to the housing via fluid line connecting plate 30 in a way that no rotating movement of the valve plate 10 with respect to the housing of bent axis hydraulic pump 1 occurs. However, a tilting movement of drum 2 is possible by a movement of moving rod 29. The bearing plate 11, however, is rotating together with rotating drum 2.

It is to be noted that a variation of angle α between the longitudinal axis 27 of drum 2 and the surface normal 28 of swash plate 4 will change the overall length of the movement of a piston 5 in its cylindrical cavity 3 during a 360° turn of the drum 2. This way, the amount of fluid that is pumped can varied so that the bent axis hydraulic pump 1 can be adapted to different pumping requirements.

In principle, a valve plate arrangement 9 according to the state of the art provides the required valve functionality, using a reliable design that is simple to manufacture. However, the valve plate arrangement 9 design becomes increasingly problematic with larger pressures.

It is to be understood that both plates 10, 11 of the valve plate arrangement 9 are subject to strongly varying pressures, where the pressure load is loading different parts of the two plates 10, 11 to a different extent at different times. This is problematic, since the pressure load will lead to some deformation of the valve plate 10 and the bearing plate 11, not only with respect to other parts of the bent axis hydraulic pump 1, but also with respect to each other. Therefore, an increased mechanical pressure between the two plates can occur easily, resulting in increased mechanical wear. On the other hand, during certain times of the actuation cycle of the bent axis hydraulic pump 1, the loading pressure can be distributed in a way that the valve plate 10 and the bearing plate 11 are not sufficiently pressed together, so that they can get out of contact to a certain extent. Therefore, a small gap might develop, which can lead to a significant loss of hydraulic oil, reducing the efficiency of the bent axis hydraulic pump 1.

Therefore, it is strongly desired to employ a design for the plates 10, 11 of the valve plate arrangement 9 that results in more rigid plates, i.e. plates 10, 11 that are less prone to deformations and elongations under the hydraulic fluid pressure loads that will occur during standard operating conditions of the bent axis hydraulic pump 1.

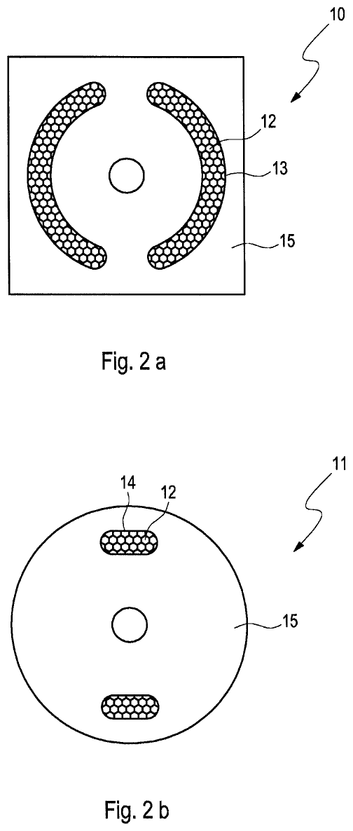

The idea is to provide a structural reinforcement element 12 within a fluid throughput orifice 13, 14 instead of the standard design for orifices of the valve plate 10 and that of the bearing plate 11. As it is not unusual for bent axis hydraulic pumps 1, the “standard orifices” of the valve plate 10 presently do show a kidney-shaped slit 13, while the orifice of the bearing plate 11 shows a circular 14 shape. Presently, two kidney-shaped slits 13 are arranged on the disc 15 of the valve plate 10 that is shown in FIG. 2a, where the respective kidney-shaped slits 13 show a structural reinforcement 12, respectively. In case of the bearing plate 11, two circular bores 14 are provided on the disc 15 of the bearing plate 11 (see FIG. 2b). Similar to the valve plate 10, the circular bores 14 comprise structural reinforcement elements 12.

The height of the structural reinforcement element 12 is essentially equivalent to the thickness of the port plate 10, 11 in the vicinity of this structural reinforcement element 12. Put in other words, the respective port plate 10, 11, including the structural reinforcement element 12, forms an essentially planar contour on both surfaces sides of the port plate 10, 11.

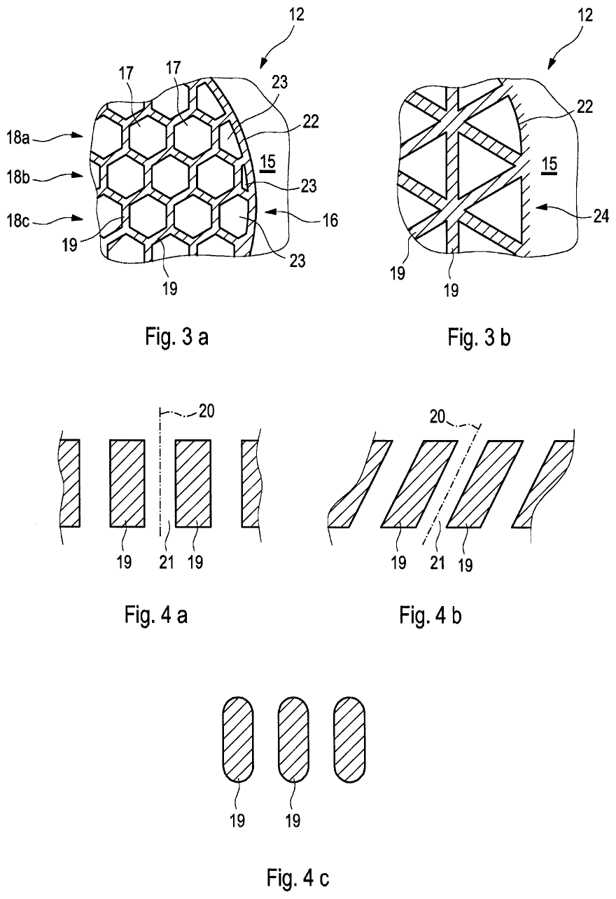

In FIG. 3, possible embodiments for a structural reinforcement 12 are shown in subfigures a and b. Both structural reinforcements 12 can be used for either valve plate 10 and/or bearing plate 11 according to FIG. 2, as well as for completely different designs.

In FIG. 3a, a honeycomb pattern 16 is shown, that serves as a structural reinforcement for an orifice (like a kidney-shaped slit 13 or circular bore 14). In the honeycomb pattern 16, a plurality of hexagons 17 is arranged side-by-side along different lines 18a, 18b, 18c. Two neighbouring lines 18a, 18b or 18b, 18c (and so on) are offset by half the distance between two neighbouring hexagons 17 within the same line 18a, 18b, 18c. Using this offset, upper and lower corners of the hexagons 17 in the neighbouring lines 18 can be arranged in an interleaved pattern.

The bordering walls 19 between two hexagons 17 can have a varying thickness depending on the requirements of the detailed embodiment. Typically, they have a thickness of some 0.5 mm. Certainly, the bordering walls 19 are an obstacle to a fluid flow through the reinforced 12 orifices 13, 14, since fluid may only pass through the hexagons 17. This is particularly true when (as it is preferred) the honeycomb pattern 16 is essentially planar to the surface side of the respective plate 10, 11 that contacts the respective other plate 10, 11 of a plate arrangement, in which the two plates can be moved relative to each other (for example the valve plate 10 and the bearing plate 11 of a valve plate arrangement). Certainly, the last statement is also valid for other designs of structural reinforcement elements. The bordering walls 19 can show a different cross-sectional shape, which can be chosen according to mechanical requirements as well as according to fluid flow requirements. As an example, the bordering walls 19 can show an essentially rectangular cross-section 19, where the corners are somewhat rounded. This is shown in FIG. 4a.

Furthermore, in FIG. 4a, the longitudinal axis 20 of the channels 21 that are formed between the bordering walls 19 may be arranged perpendicular to the surface of the disc 15. However, this is not a mandatory requirement. Instead, it is also possible to arrange the longitudinal axes of the channels 21 between two neighbouring was 19 in a way that an angle, deviating from 90° is formed between the longitudinal axes 20 and the surface of the plate 15. Is to be noted that the angle does not necessarily has to be the same over the complete area of an orifice 13, 14. Instead, the angle might vary and be chosen locally in order to be optimised for the current phase of the pumping cycle of the respective piston 5 in its respective cavity 3.

Furthermore, in FIG. 4c it is shown that the bordering walls 19 can also have a shape that is significantly different from a rectangular design (with or without rounded corners). As an example, the neighbouring walls 19 can show an elliptical cross-section. Such a cross-section usually has a comparatively low fluid flow resistance. To even further reduce the fluid flow resistance, a drop like shape can be chosen as well. A drop-like shape is known to show a very low fluid flow resistance, so this might be a preferred design.

Coming back to FIG. 3a and the honeycomb pattern 16 shown therein, additional attention is drawn to the contour line 22 of the fluid flow orifice 13, 14 that would define the orifice's wall in case there would be no structural reinforcement 12 present. This contour line 22 is shown in FIG. 3a. To follow this contour line 22 as close as possible with the honeycomb pattern 16, in the vicinity of the contour lines 22 a plurality of “partial hexagons” 23 is/are provided. These “partial hexagons” 23 are shaped in a way that they essentially follow the contour line 22 on one side, while they follow the shape of the neighbouring “full” hexagon 17 on the other side. In case the partial hexagons 23 would become too small, they are simply omitted.

However, the structural reinforcement 12 does not necessarily has to show a honeycomb pattern 16 design. Instead, any kind of a truss-like arrangement 24 of bordering walls 19 (that includes geometrical shapes of the same and/or different type, size, angular arrangement, number and so on) can be used as well, as it is shown in FIG. 3b. The truss-like arrangement 24 is connected along the contour line 22 of the respective orifice 13, 14 (differently shaped orifice) to the remaining disc 15 of the respective plate 10, 11.

The bordering walls 19 of the truss-like arrangement 24 can show a similar variety of cross sections, just like the honeycomb structure 16 that is shown in FIG. 3a. Reference is made to FIG. 4, showing different possible embodiments for the cross sections of such bordering walls 19.

While the present disclosure has been illustrated and described with respect to a particular embodiment thereof, it should be appreciated by those of ordinary skill in the art that various modifications to this disclosure may be made without departing from the spirit and scope of the present disclosure.

What is claimed is:

1. A port plate for a fluid throughput regulating device, comprising at least one fluid blocking surface section and at least one fluid passage surface section that is arranged within said at least one fluid blocking surface section, wherein at least one structural reinforcement element is arranged within the fluid passage orifice of said at least one fluid passage surface section.

2. The port plate according to claim 1, wherein it is designed and arranged as a valve plate and/or as a bearing plate for a fluid working machine, preferably for a high pressure fluid working machine, more preferred for a hydraulic fluid working machine, even more preferred for a high-pressure hydraulic fluid working machine.

3. The port plate according to claim 1, wherein a plurality of structural reinforcing elements is provided in the fluid passage orifice of said at least one fluid passage surface section, where said plurality of structural reinforcing elements is preferably at least in part interconnected with each other, more preferably at least partially forming a truss-like design and/or a honeycomb-like design.

4. The port plate according to claim 3, wherein said at least one structural reinforcement element is designed in a way that it shows fluid flow enhancing properties.

5. The port plate according to claim 3, wherein said at least one structural reinforcement element is connected to said at least fluid blocking surface section along a circumferential part of the respective fluid passage surface section.

6. The port plate according to claim 3, wherein said at least one structural reinforcing element and/or said at least one fluid blocking surface section is/are designed at least in part as a single piece.

7. The port plate according to claim 1, wherein essentially no structural reinforcement element protrudes at least one surface side that is formed by at least one fluid blockage surface section and/or in that said port plate forms essentially a planar contour on at least one surface side.

8. The port plate according to claim 1, wherein at least one of said at least one fluid passage surface sections has a kidney like shape and/or in that said at least one of said at least one fluid passage surface section is used for alternately enabling and blocking/hindering a fluid flow through said fluid passage surface section in combination with an additional device.

9. The port plate according to claim 1, wherein it is at least partially manufactured using at least one manufacturing technique, taken from the group comprising material removal techniques, additive manufacturing techniques, 3-D printing techniques, moulding techniques, sintering techniques, material connection techniques, soldering techniques, welding techniques and pressure welding techniques.

10. A fluid valve unit, comprising at least two elements that can be moved relative to each other, in particular that can be rotated relative to each other, wherein at least one said at least two elements is designed at least in part as a port plate according to claim 1.

11. The fluid working device, comprising at least one fluid valve unit according to claim 10 and/or at least one port plate.

12. A method for producing a port plate according to claim 1, for producing a fluid valve unit according to claim 10 and/or for producing a fluid working device wherein at least in part at least a manufacturing technique is used, that is taken from the group comprising material removal techniques, additive manufacturing techniques, 3-D printing techniques, moulding techniques, sintering techniques, material connection techniques, soldering techniques, welding techniques, and pressure welding techniques.

13. The fluid valve unit according to claim 10, wherein at least a first one of said at least two elements that can be moved relative to each other shows at least a structural reinforcement element that forms at least partly an essentially planar contour of the element on at least the surface side that is neighbouring at least a second one of said at least two elements.

14. The port plate according to claim 2, wherein a plurality of structural reinforcing elements is provided in the fluid passage orifice of said at least one fluid passage surface section, where said plurality of structural reinforcing elements is preferably at least in part interconnected with each other, more preferably at least partially forming a truss-like design and/or a honeycomb-like design.

15. The port plate according to claim 1, wherein said at least one structural reinforcement element is designed in a way that it shows fluid flow enhancing properties.

16. The port plate according to claim 2, wherein said at least one structural reinforcement element is designed in a way that it shows fluid flow enhancing properties.

17. The port plate according to claim 1, wherein said at least one structural reinforcement element is connected to said at least fluid blocking surface section along a circumferential part of the respective fluid passage surface section.

18. The port plate according to claim 2, wherein said at least one structural reinforcement element is connected to said at least fluid blocking surface section along a circumferential part of the respective fluid passage surface section.

19. The port plate according to claim 4, wherein said at least one structural reinforcement element is connected to said at least fluid blocking surface section along a circumferential part of the respective fluid passage surface section.

20. The port plate according to claim 4, wherein said at least one structural reinforcing element and/or said at least one fluid blocking surface section is/are designed at least in part as a single piece.
